(19) United States
(12) Patent Application Publication
(10) Pub. No.: US 2015/0001386 A1
(43) Pub. Date: Jan. 1, 2015

(54) MALDI MASS SPECTROMETRY OF PEPTIDES

(71) Applicant: SHIMADZU CORPORATION, Kyoto-shi (JP)

(72) Inventors: Hiroki Kuyama, Kyoto-shi (JP); Yusaku Hioki, Kyoto-shi (JP)

(21) Appl. No.: 13/933,091

(22) Filed: Jul. 1, 2013

(51) Int. Cl. H01J 49/00; H01J 49/04

(52) U.S. Cl. CPC H01J 49/0031; H01J 49/0418
USPC 250/282

(57) ABSTRACT

The present invention provides a mass spectrometry method capable of detecting a smaller amount of peptide. A method for analyzing a peptide by matrix-assisted laser desorption/ionization mass spectrometry, comprising the steps of: dropping, onto a target plate, a peptide solution using, as a solvent, an aqueous solution containing 15 to 50 vol % of acetonitrile, and a matrix solution that uses, as a solvent, an aqueous solution containing 15 to 50 vol % of acetonitrile and that contains 0.05 to 1 mg/mL α-cyano-4-hydroxycinnamic acid, respectively, to prepare a droplet of peptide-matrix mixed solution; removing the solvent from the droplet of peptide-matrix mixed solution to prepare a sample for mass spectrometry as a residue; and irradiating the sample for mass spectrometry with laser to detect the peptide.

### BACKGROUND OF THE INVENTION

1. Field of the Invention

The present invention relates to a technique for analyzing a peptide by MALDI (Matrix-Assisted Laser Desorption/Ionization) mass spectrometry. The present invention is applied to fields related to pharmaceutical production, commissioned analysis, food, hygiene, forensic science analysis, etc.

2. Disclosure of the Related Art

The central objective of analytical science is high sensitive analysis. MALDI mass spectrometry is an important technique supporting analytical science, and is therefore always expected to be more sensitive.

In order to achieve high sensitive analysis of peptides by MALDI mass spectrometry, various approaches have been tried such as selection of a matrix material at the time of sampling of a sample for mass spectrometry, adjustment of pH of a solution used, use of a target plate having a water-repellent surface (Non-Patent Document 1: Hudson Surface Technology's Homepage “μ Focus”), use of a matrix additive, and the like.

Non-Patent Document 1: “μ Focus”, [online], Hudson Surface Technology, searched on Jun. 11, 2012, Internet<URL: http://www.maldiplate.com/catalog/category/sample-plates/%CE%BCfocus>

### SUMMARY OF THE INVENTION

Various approaches have been tried to increase the sensitivity of MALDI mass spectrometry but are fragmentary, and systematic studies have not been made on parameters such as matrix concentration or the others. Therefore, a sampling method which is not based on systematic studies has been used as a common method. Specifically, the following method is commonly used as a simple sampling method in a mass-spectrometry system in which a peptide is a substance to be detected, α-cyano-4-hydroxycinnamic acid is a matrix, and acetonitrile is used in a solvent: a 10 mg/mL α-cyano-4-hydroxycinnamic acid solution using, as a solvent, a solution obtained by mixing acetonitrile and an aqueous 0.1 vol % trifluoroacetic acid solution in the same volume, and a peptide solution using, as a solvent, an aqueous 0.1 vol % trifluoroacetic acid solution are dropped onto a stainless steel target plate, respectively, and mixed; and then the solvent is removed by volatilization to obtain a residue as a sample for mass spectrometry. In the case of MALDI mass spectrometry using such a sampling method, the detection limit for peptides is 10 fmol.

An object of the present invention is to provide a mass spectrometry method capable of detecting a smaller amount of peptide by improving sampling conditions.

The present inventors have found that the above object of the present invention can be achieved by containing acetonitrile not only in a matrix solution but also in a peptide solution before dropping onto a target plate, and by reducing the amounts of a matrix material and acetonitrile used, which has led to the completion of the present invention.

The present invention includes the following.

A method for analyzing a peptide by matrix-assisted laser desorption/ionization mass spectrometry, comprising the steps of:

dropping, onto a target plate, a peptide solution using, as a solvent, an aqueous solution containing 15 to 50 vol % of acetonitrile, and a matrix solution that uses, as a solvent, an aqueous solution containing 15 to 50 vol % of acetonitrile and that contains 0.05 to 1 mg/mL α-cyano-4-hydroxycinnamic acid, respectively, to prepare a droplet of peptide-matrix mixed solution;

removing the solvent from the droplet of peptide-matrix mixed solution to prepare a sample for mass spectrometry as a residue; and

irradiating the sample for mass spectrometry with laser to detect the peptide.

In the present specification, a concentration of MeCN in a peptide solution may be expressed as “X” (unit: vol %), a concentration of MeCN in a matrix solution may be expressed as “Y” (unit: vol %), and a concentration of a matrix in a matrix solution may be expressed as “n” (unit: mg/mL), and the amounts of each of them used in the preparation of a sample for mass spectrometry may be collectively expressed as “X−Y(n)”. That is, in the present invention, each of the components are used so that X in “X−Y(n)” is 15 to 50, Y in “X−Y(n)” is 15 to 50, and n in “X−Y(n)” is 0.05 to 1.0 to prepare a sample for mass spectrometry.

According to the present invention, it is possible to provide a mass spectrometry method capable of detecting a smaller amount of peptide. More specifically, the mass spectrometry method according to the present invention achieves a 100- to 1,000-fold increase in sensitivity (i.e., a detection limit of 1/1,000 to 1/100) as compared to a conventional method (i.e., a mass spectrometry method using a sampling method in which α-cyano-4-hydroxycinnamic acid is used as a matrix and an acetonitrile-containing aqueous solution is used as a solvent).

### BRIEF DESCRIPTION OF THE DRAWINGS

FIG. 1 is a graph showing the SN ratio of detection of a peptide when the value of X (concentration of MeCN in a matrix solution) in the composition X−Y(n) was varied (Experimental Example 1).

FIG. 2 is a graph showing the SN ratio of detection of 1 fmol of the peptide when the value of n (matrix concentration) in the composition X−Y(n) was varied (Experimental Example 2).

FIG. 3 is a graph showing the SN ratio of detection of 100 amol of the peptide when the value of n (matrix concentration) in the composition X−Y(n) was varied (Experimental Example 2).

FIG. 4 shows the images of matrix-peptide mixed solutions prepared by varying the composition X−Y(n) or their residues (Experimental Example 3).

FIG. 5 shows mass spectra (A) to (E) obtained when different amounts of the peptide were detected by a method according to the present invention in which the composition X−Y(n) was 20-20(0.1); and mass spectra (a) to (e) obtained when different amounts of the peptide were detected by a conventional method in which the composition X−Y(n) was 0-50(10) (Experimental Example 4).

### DETAILED DESCRIPTION OF THE INVENTION

In the present invention, an object to be analyzed by mass spectrometry is a peptide. The peptide may be a peptide isolated and/or purified, or a peptide coexisting with other substances. Further, the peptide may be a peptide fragment obtained by protein digestion, and in this case, the peptide fragment may be present in a digest when used in the present invention.

The molecular weight of the peptide is not particularly limited, but may be, for example, 500 to 10,000, and preferably 1,000 to 3,000.

The physical properties of the peptide are not particularly limited, either. Therefore, the peptide may be either a hydrophilic peptide or a hydrophobic peptide, and further may be any of an acidic peptide, a neutral peptide, and a basic peptide.

In the present invention, a peptide solution and a matrix solution are prepared separately from each other.

A solvent of the peptide solution is an aqueous solution containing acetonitrile and trifluoroacetic acid. The concentration of acetonitrile is 15 to 50 vol %. The lower limit of this range may be 16, 17, 18, 19, or 20 vol %. The upper limit of the above range may be 45, 40, 30, 25, or 20 vol %. If the concentration of acetonitrile is less than the above range, the loss of a peptide is likely to occur during preparation or an SN ratio tends to decrease. If the concentration of acetonitrile exceeds the above range, the tendency of the SN ratio to decrease is not as strong as that at the time when the concentration of acetonitrile is less than the above range, but the area of contact between a droplet formed by dropping onto a target plate and the target plate tends to increase.

The concentration of trifluoroacetic acid is not particularly limited, but is, for example, 0.05 to 2 vol %, and preferably 0.05 to 1 vol %.

A solvent of the matrix solution is also an aqueous solution containing acetonitrile and trifluoroacetic acid. The concentration of acetonitrile is 15 to 50 vol %. The lower limit of this range may be 16, 17, 18, 19, or 20 vol %. The upper limit of the above range may be 45, 40, 30, 25, or 20 vol %. If the concentration of acetonitrile is less than the above range, an SN ratio tends to decrease. If the concentration of acetonitrile exceeds the above range, the tendency of the SN ratio to decrease is not as strong as that at the time when the concentration of acetonitrile is less than the above range, but the area of contact between a droplet formed by dropping onto a target plate and the target plate tends to increase.

The concentration of trifluoroacetic acid is not particularly limited, but is, for example, 0.05 to 2 vol %, and preferably 0.05 to 1 vol %.

As a matrix, α-cyano-4-hydroxycinnamic acid is used.

The matrix is used at such a concentration that, even when the matrix solution is mixed with the peptide solution on a target plate to form a peptide-matrix mixed solution, the matrix is not precipitated out of the mixed solution in an environment where the mixed solution is prepared. Specifically, the concentration of the matrix is 0.05 to 1.0 mg/mL. The lower limit of this range may be 0.06, 0.07, 0.08, 0.09, or 0.1 mg/mL. The upper limit of the above range may be 0.45, 0.40, 0.35, 0.30, 0.25, or 0.20 mg/mL. If the concentration of the matrix is less than the above range, an SN ratio tends to decrease. If the concentration of the matrix exceeds the above range, a residue obtained as a sample for mass spectrometry tends to be spread without forming a small mass when the solvent is removed from a droplet of peptide-matrix mixed solution on a target plate, and therefore sensitivity tends to be poor.

The solvent used in the matrix solution and the solvent used in the peptide solution may have the same composition. Alternatively, a difference in the concentration of acetonitrile and/or trifluoroacetic acid in the solvent in each of the solutions may be, for example, within 20%, preferably within 10%, more preferably within 5%, and even more preferably within 3% (volumetric basis).

The peptide solution and the matrix solution are dropped to the same position on a target plate for mass spectrometry, specifically, into the same well to prepare a droplet of peptide-matrix mixed solution on the target plate. The peptide solution and the matrix solution may be dropped in arbitrary order, and therefore the matrix solution may be dropped first or the peptide solution may be dropped first.

The volume of the peptide solution dropped and the volume of the matrix solution dropped may be the same. Alternatively, a difference in volume between both the solutions may be, for example, within 20%, preferably within 10%, more preferably within 5%, and even more preferably within 3% (volumetric basis).

The volume of one droplet of peptide-matrix mixed solution is, for, example, 10 nL to 2 μL, and preferably 20 nL to 1 μL.

The solvent is removed from the droplet of peptide-matrix mixed solution to prepare a sample for mass spectrometry as a residue. The removal of the solvent may be performed by naturally volatilizing the solvent by allowing the droplet to stand in an environment where the droplet has been prepared. However, pressure reduction or heating may be actively performed.

The amount of a peptide contained in one residue (i.e., a sample for mass spectrometry) may be, for example, 1 amol or more. The lower limit of this range may be 5 amol or 10 amol. The upper limit of the above range may be, for example, 1 μmol, 100 fmol, 10 fmol, 1 fmol, or 100 amol.

The target plate for mass spectrometry is not particularly limited, and a generally-available metal (e.g., stainless steel) plate with wells may be used.

It is known that sensitivity is enhanced by making the area of contact between a residue and a target plate smaller than that between a droplet and the target plate in the process of removing a solvent from a droplet of analysis object-matrix mixed solution to obtain a residue as a sample for mass spectrometry (HST μ Focus Technology, version 2010 Aug. 24, Hudson Surface Technology). Some target plates for mass spectrometry are subjected to surface treatment (e.g., water-repellent treatment) in order to promote such a reduction in the area of contact on a target plate. In the present invention, the target plate may or may not be subjected to such a surface treatment. The present invention is particularly superior in sensitivity-enhancing effect to a conventional method when a target plate not being subjected to such treatment is used.

In mass spectrometry, the residue is irradiated with laser to detect a peptide. A mass spectrometer used in the present invention is not particularly limited as long as it is equipped with a MALDI (Matrix-Assisted Laser Desorption/Ionization) ion source. Examples of the mass spectrometer include a MALDI-TOF (Matrix-Assisted Laser Desorption/Ionization-Time of Flight) mass spectrometer, a MALDI-IT (Matrix-Assisted Laser Desorption/Ionization-Ion Trap) mass spectrometer, a MALDI-IT-TOF (Matrix-Assisted Laser Desorption/Ionization-Ion Trap-Time of Flight) mass spectrometer, a MALDI-FTICR (Matrix-Assisted Laser Desorption/Ionization-Fourier Transform Ion Cyclotron Resonance) mass spectrometer, and the like.

It is to be noted that according to the present invention, a peptide can be detected at sufficient sensitivity without adopting means conventionally used to enhance sensitivity such as combination use with a matrix additive or use of the above-described surface-treated target plate and/or other means. However, the present invention is not intended to exclude the adoption of such means conventionally used to enhance sensitivity.

### EXAMPLES

Hereinbelow, the present invention will be described more specifically with reference to examples, but is not limited to the following examples.

In the following description, CHCA represents α-cyano-4-hydroxycinnamic acid, MeCN represents acetonitrile, and TFA represents trifluoroacetic acid.

The sampling of a sample for mass spectrometry was performed by an on-target mix method, i.e., by a method in which a peptide solution and a matrix solution prepared separately from each other were dropped, respectively, into the same well of a MALDI target plate (SUS304 target plate for AXIMA series manufactured by SHIMADZU CORPORATION) to mix the peptide solution and the matrix solution on the target plate.

A solvent was volatilized from a droplet of peptide solution-matrix mixed solution to obtain a residue (dried-droplet method), and the residue was irradiated with laser to perform mass spectrometry.

The mass spectrometry measurement was performed using AXIMA Performance (manufactured by SHIMADZU CORPORATION) in reflectron positive mode.

### Experimental Example 1

### Method in which Solvent Composition was Varied

Adrenocorticotropic hormone fragment 18-39 (ACTH (18-39): m/z 2464.20, monoisotopic), as a peptide to be analyzed, was analyzed by mass spectrometry.

The peptide was analyzed by mass spectrometry using an on-target mix method and a dried-droplet method, when X was 0 and Y was 10, 20, 30, 40, or 50 in the system X−Y(n), and when X and Y in the system X−Y(n) were 10, 20, 30, 40, or 50 (in both cases, n=0.1).

More specifically, for example, when sampling was performed to achieve a sampling system X−Y(n) of 0-50(0.1), a peptide solution using, as a solvent, an aqueous 0.1% TFA solution, and a CHCA solution using, as a solvent, a solution obtained by mixing MeCN and an aqueous 0.1% TFA solution in a volume ratio of 1:1 and containing 0.1 mg/mL CHCA dissolved in said solution were prepared, and these solutions were each dispensed in an amount of 0.5 μL using a pipette into the same well on a target plate and mixed, and the solvent was volatilized to obtain a residue as a sample for mass spectrometry.

It is to be noted that the amount of the peptide ACTH (18-39) per one residue in one well was 1 fmol.

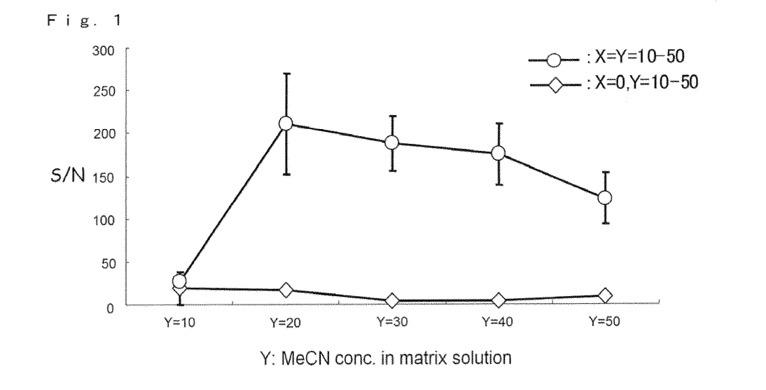

The residue was irradiated with laser to perform mass spectrometry measurement to determine an S/N ratio. The results are shown in FIG. 1. In the figure, the vertical axis represents an S/N ratio as an indicator of sensitivity, and the horizontal axis represents the value of Y. As shown in the figure, in the cases of sampling modes in which MeCN was contained in both the peptide solution and the matrix solution as a solvent and X=Y=20, 30, 40, or 50, a 100- to 200-fold S/N ratio-enhancing effect was observed as compared to the other sampling modes.

### Experimental Example 2

### Method in which CHCA Concentration was Varied

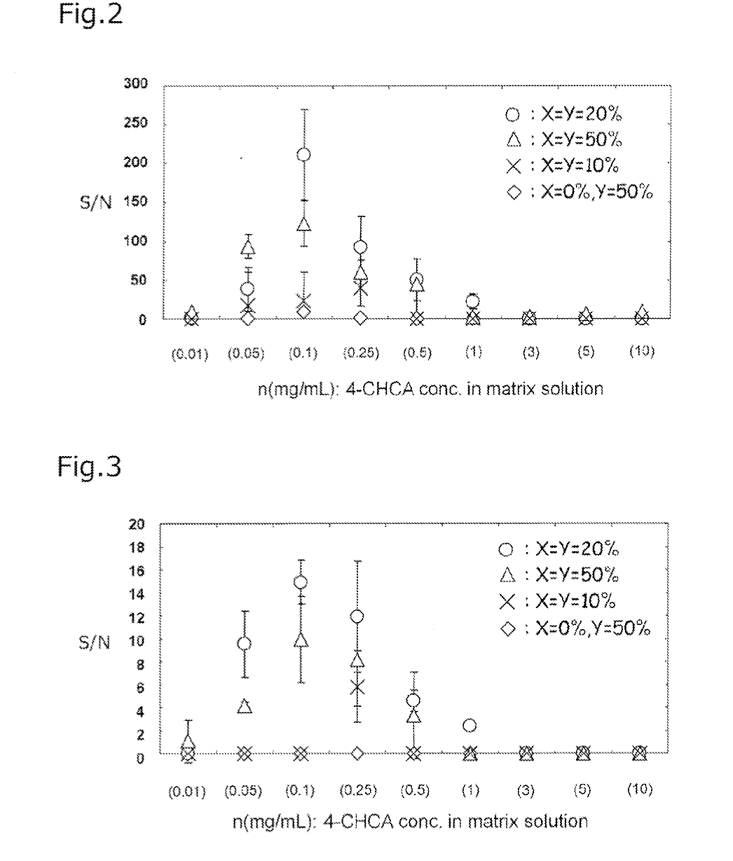

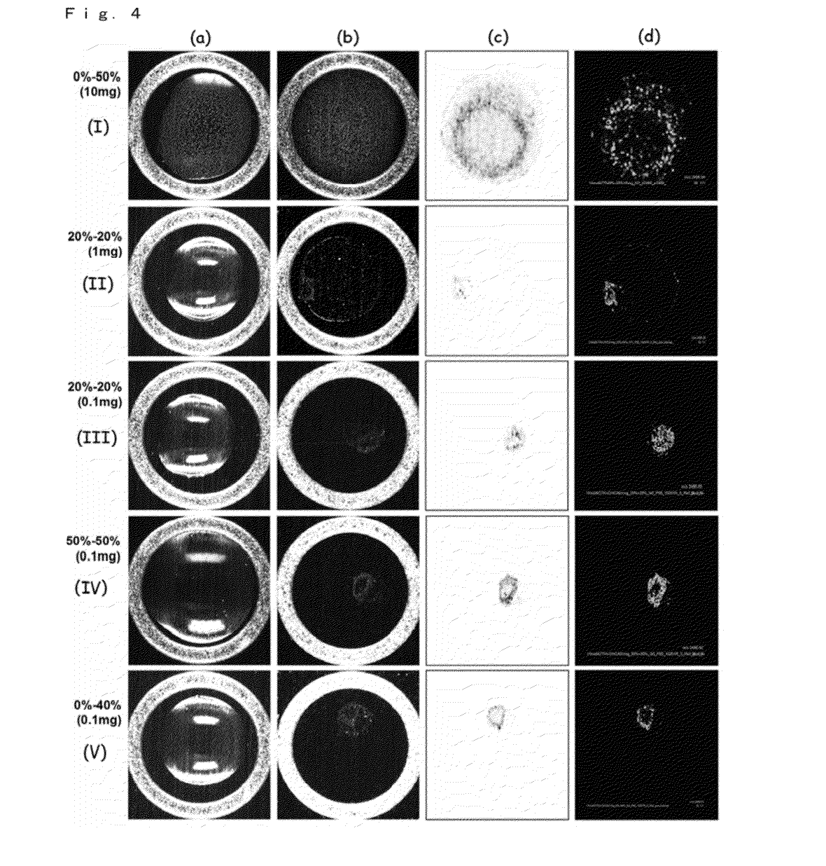

In each of the three modes in which X and Y in the system X−Y(n) were 50, 20, or 10, the value of n (CHCA concentration) was serially diluted from a saturation concentration. FIG. 2 shows the results of determining an S/N ratio in mass spectrometry when sampling was performed so that the amount of the peptide (ACTH (18-39) per one well was 1 fmol. Similarly, FIG. 3 shows the results when sampling was performed so that the amount of the peptide per one well was 100 amol. It is to be noted that in FIGS. 2 and 3, the results of the mode in which X−Y(n) were 0-50(10) was also shown as reference data.

### Experimental Example 3

### Influence of Composition X−Y(n) on Spot Area

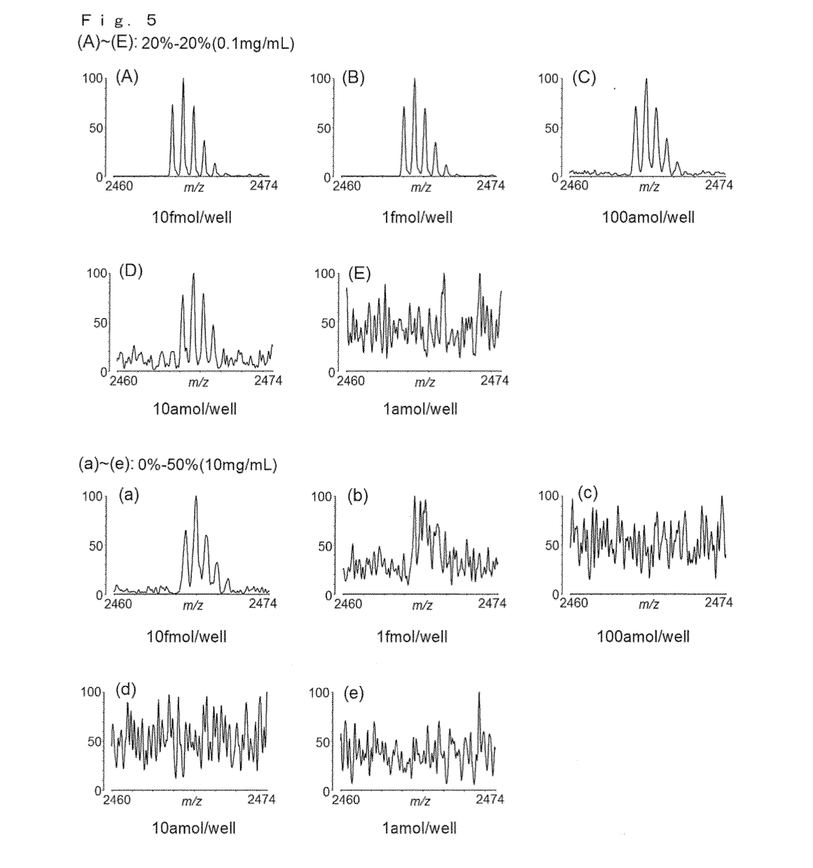

Comparisons were made among a case where X−Y(n) was 0-50(10) (I) as a reference, a case where X−Y(n) was 20-20(1) (II), a case where X−Y(n) was 20-20(0.1) (III), a case where X−Y(n) was 50-50(0.1) (IV), and a case where X−Y(n) was 0-40(0.1) (V). FIG. 4 shows the optical microscope image (a) of a droplet of peptide-matrix mixed solution just after dropping, the optical microscope image (b) of a residue after drying the droplet, an image (c) by imaging peptide (ACTH) signals obtained by the MS measurement of the residue, and the heat map (d) of the image (c) of each of the cases (I) to (V).

A general tendency is that when the spot areas of droplets of peptide-matrix mixed solution before drying (i.e., the areas of contact between the droplets and a target plate) are similar, a relatively smaller spot area of a residue after drying (i.e., a relatively smaller area of contact between the residue and the target plate) than the spot area of the droplet of peptide-matrix mixed solution before drying is more advantageous for enhancing sensitivity. As a result of a comparison of the optical microscope images (b) of a residue after drying a droplet shown in FIG. 4 of the cases (I) to (V), a residue having a smaller spot area was obtained when the value of n (CHCA concentration) in X−Y(n) was smaller. For example, when the value of X and the value of Y in the composition X−Y(n) were the same, that is, when the images (b) of the cases (II) and (III) were compared, the spot area of a residue in the case (III), in which the value of n (CHCA concentration) in X−Y(n) was smaller, was about ¼ of that in the case (II) in which the value of n was larger. The size of spot area of a residue corresponded also to the detection area of peptide signals in the images (c) and (d). (However, in the case (II), the spot area was more easily determined in the image (d) than in the image (c).)

Further, the images (d) clearly indicated that a difference in sensitivity was generated even when the degree of a reduction in spot area achieved by drying a droplet into a residue was similar. Specifically, there was not much difference in the images (a), (b), and (c) between the cases (III) and (V), but only the images (d) clearly indicated that there was a difference in the intensity of peptide signals.

Further, as a result of a comparison of the images (a) of the cases (I) and (IV), it was found that the spot area of a droplet was larger when the concentration of MeCN was higher. A droplet having a large spot area is undesirable because there is a fear that the mixed solution overflows a well. From the viewpoint of such operability, it was found that the concentration of MeCN used was preferably low.

From the above, the conclusion drawn from this experimental example was that the case (III), that is, the case where X−Y(n) was 20-20(0.1) was optimal.

### Experimental Example 4

### Comparison of Sensitivity for Detection of Peptide Between Method According to Present Invention and Conventional Method

The detection limit for the peptide ACTH (18-39) of a method according to the present invention in which the composition X−Y(n) was 20-20(0.1) and that of a conventional method in which the composition X−Y(n) was 0-50(10) were determined. It is to be noted that a peptide solution and a CHCA solution used were each placed on a target plate in an amount of 0.5 The obtained mass spectra are shown in FIG. 5. In FIG. 5, (A) to (E) were obtained by the method according to the present invention in which the composition X−Y(n) was 20-20(0.1), and (a) to (e) were obtained by the conventional method in which the composition X−Y(n) was 0-50(10). When a detection criterion was defined as an S/N ratio of 2, as can be seen from a comparison between (a) to (e) and (A) to (E), the method according to the present invention could detect the peptide even when the amount of the peptide was 10 amol/well, whereas the detection limit for the peptide of the conventional method was 10 fmol/well. This indicates that the method according to the present invention achieves a 1,000-fold increase in sensitivity as compared to the conventional method.

### Experimental Example 5

### Method in which Peptide was Varied

The detection limits for peptides other than ACTH (18-39) of a method according to the present invention in which the composition X−Y(n) was 20-20(0.1) and those of a conventional method in which the composition X−Y(n) was 0-50(10) were also determined in the same manner as in Example 4.

The peptides examined in this experimental example are as follows.

ACTH (18-39): adrenocorticotropic hormone fragment (18-39); RPVKVYPNGAEDESAEAFPLEF (Sequence ID No. 1); m/z 2464.20 (monoisotopic)

ACTH (1-17): adrenocorticotropic hormone fragment (1-17); SYSMEHFRWGKPVGKKR (Sequence ID No. 2); m/z 2092.08 (monoisotopic)

GluFib: [Glu¹]-Fibrinopeptide; EGVNDNEEGFFSAR (Sequence ID No. 3); m/z 1569.67 (monoisotopic)

P₁₄R: PPPPPPPPPPPPPPR (Sequence ID No. 4); m/z 1532.86 (monoisotopic)

Ang I: Angiotensin I; DRVYIHPFHL (Sequence ID No. 5); m/z 1295.68 (monoisotopic)

The detection limits for these peptides were summarized in Table 1 together with the physical property parameters (BB Index (Bull and Breese Index), HPLC Index, and PI (Isoelectric Point)) of these peptides and the rates of enhancement in sensitivity achieved by the present invention as compared to the conventional method (Enhancement rate).

TABLE 1

| | Adrenocorticotropic | | | | |
|---|---|---|---|---|---|
| | hormone fragment | Adrenocorticotropic | | | |
| | 18-39 | hormone fragment | [Glu¹]- | | |
| | (ACTH(18-39)): | 1-17 | Fibrinopeptide | | angiotensin I |
| | RPVKVYPNGAEDES | (ACTH(1-17)): | (GluFib): | P₁₄R: | (AngI): |
| | AEAFPLEF (m/z | SYSMEHFRWGKPV | EGVNDNEEGFFSAR | PPPPPPPPPPPPP | DRVYIHPFHL |
| | 2464.20: | GKKR (m/z 2092.08: | (m/z 1569.67: | PR (m/z 1532.86: | (m/z 1295.68: |
| | monoisotopic) | monoisotopic) | monoisotopic) | monoisotopic) | monoisotopic) |
| BB Index | −380 | 690 | 3470 | −1690 | −4290 |
| HPLC Index | 58.9 | 17.5 | 3.5 | 67.8 | 49.6 |
| PI | 4.25 | 10.45 | 4 | 10.18 | 6.92 |
| 0-50(10) | 10 fmol/well | 1 fmol/well | 1 fmol/well | 1 fmol/well | 1 fmol/well |
| 20-20(0.1) | 10 amol/well | 10 amol/well | 10 amol/well | 10 amol/well | 1 amol/well |
| Enhancement | 1000 | 100 | 100 | 100 | 1000 |
| rate | | | | | |

As can be seen from the results shown in Table 1, the method according to the present invention has a 100- to 1,000-fold higher sensitivity for detection of the peptides as compared to the conventional method.

### Experimental Example 6

### Examples of Application to Protein Digest

The sensitivity for detection of a protein digest by a method according to the present invention in which the composition X−Y(n) was 20-20(0.1) and that by a conventional method in which the composition X−Y(n) was 0-50(10) were determined.

As the protein digest, a commercially-available bovine serum albumin (BSA) digest was used, and the BSA digest was directly serially diluted without being subjected to treatments such as desalination using ZipTipC18 or the like and analyzed by mass spectrometry to obtain mass spectra. It is to be noted that studies were made on cases where the amounts of the protein digest per one well were 10 fmol, 1 fmol, 100 amol, and 10 amol (in terms of the amount of BSA).

As indicators of detection sensitivity, a value obtained by a database search engine (Mascot search) and a value obtained by a peptide coverage (coverage) calculated by manual pickup were used. The obtained results are shown in Table 2. In Table 2, a score obtained by Mascot search was also shown in addition to the above values.

TABLE 2

| | coverage (%) | | | | | |
|---|---|---|---|---|---|---|
| | 0-50 (10) | | | 20-20 (0.1) | | |
| | Mascot search | | | Mascot search | | |
| | (PMF) | | Manual pickup | (PMF) | | Manual pickup |
| | score | coverage | coverage | score | coverage | coverage |
| 10 fmol/well | 164 | 57 | 63 | 239 | 69 | 74 |
| 1 fmol/well | 27 | 33 | 27 | 214 | 72 | 62 |
| 100 amol/well | 12 | 19 | 13 | 104 | 49 | 45 |
| 10 amol/well | — | — | 5.2 | 43 | 25 | 17 |

In all the cases of the various amount of the digest, a difference in detection sensitivity between the method according to the present invention in which the composition X−Y(n) was 20-20(0.1) and the conventional method in which the composition X−Y(n) was 0-50(10) appeared as significant differences in the peptide coverage and the score. Further, differences in the peptide coverage and the score between the method according to the present invention and the conventional method were larger when the amount of the digest was smaller. It is estimated that these results reflect a significant sensitivity-enhancing effect of the method according to the present invention.

What is claimed is:

1. A method for analyzing a peptide by matrix-assisted laser desorption/ionization mass spectrometry, comprising the steps of:
dropping, onto a target plate, a peptide solution using, as a solvent, an aqueous solution containing 15 to 50 vol % of acetonitrile, and a matrix solution that uses, as a solvent, an aqueous solution containing 15 to 50 vol % of acetonitrile and that contains 0.05 to 1 mg/mL α-cyano-4-hydroxycinnamic acid, respectively, to prepare a droplet of peptide-matrix mixed solution;
removing the solvent from the droplet of peptide-matrix mixed solution to prepare a sample for mass spectrometry as a residue; and
irradiating the sample for mass spectrometry with laser to detect the peptide.


SEQUENCE LISTING (5 sequences)

SEQ ID NO: 1 - protein, 22 aa, human
RPVKVYPNGAEDESAEAFPLEF

SEQ ID NO: 2 - protein, 17 aa, human
SYSMEHFRWGKPVGKKR

SEQ ID NO: 3 - protein, 14 aa, human [sequence omitted]

SEQ ID NO: 4 - protein, 15 aa, artificial
  synthetic peptide
PPPPPPPPPPPPPPR

SEQ ID NO: 5 - protein, 10 aa, human
DRVYIHPFHL